(19) United States
(12) Patent Application Publication
(10) Pub. No.: US 2006/0151412 A1
(43) Pub. Date: Jul. 13, 2006

(54) Macro/micro crane

(76) Inventors: Richard J. Norcross, Darnestown, MD (US); Edward L. May, Columbia, MD (US); Roger Bostelman, Frederick, MD (US); Paul M. Kjolseth, Edgewater, MD (US)

Correspondence Address: DUANE, MORRIS, LLP, 3200 SOUTHWEST FREEWAY, SUITE 3150, HOUSTON, TX, 77027, US

(21) Appl. No.: 10/983,515

(22) Filed: Nov. 8, 2004

(51) Int. Cl. B66C 23/52

(52) U.S. Cl. 212/308

(57) ABSTRACT

A composite crane is disclosed which may be used to enable cargo handling at sea to move cargo from one ship to another ship. The composite crane may comprise a micro crane assembly, adapted to control motion of a lifting device; a macro crane assembly adapted to be in communication with and control motion of the micro crane; and a controller, operatively in communication with at least one of (i) the micro crane assembly or (ii) the macro crane assembly, the controller adapted to maintain a predetermined portion of the composite crane in a substantially steady state relative to inertial space. Using a control algorithm accessible to the controller, the controller may maintain a support platform for the micro crane assembly in a substantially steady state relative to inertial space or moving to compensate for some of the movement of the target platform. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

### FIELD OF INVENTION

The present inventions relate generally to the field of cargo handling tools suitable for use at sea. More specifically, the present inventions relate to cargo handling cranes suitable for use at sea to move cargo from one ship to another ship.

### BACKGROUND OF THE INVENTION

Being able to offload heavy cargo in unprotected water with sea states of five (5) or higher is a capability that is desirable. Container ship cranes are not suitable for operation in other than calm seas or in port. Existing offshore crane technology can provide compensated motion for lift lines in a vertical sense relative to a base platform and some have been adapted with tag lines or crane tip motion control to provide limited lateral compensation. However, none are adapted to accommodate lateral and/or rotational disturbances of a second ship moving in the seaway.

It is desirable, therefore, to have a cargo lifting and movement system that is adaptable for use at sea between two ships which can provide compensated and controlled cargo lifting.

### BRIEF DESCRIPTION OF THE DRAWINGS

The various drawings supplied herein are representative of one or more embodiments of the present inventions.

FIG. 1 is a view in partial perspective of two ships, cargo, and a composite crane;

FIG. 2 is a view in partial perspective of an exemplary embodiment of a composite crane;

FIG. 3 is a view in partial perspective of a close-up of an exemplary embodiment of a composite crane;

FIG. 4 is flowchart of a first exemplary method; and

FIG. 5 is a flowchart of a second exemplary method.

### DETAILED DESCRIPTION OF EXEMPLARY EMBODIMENTS OF THE INVENTION

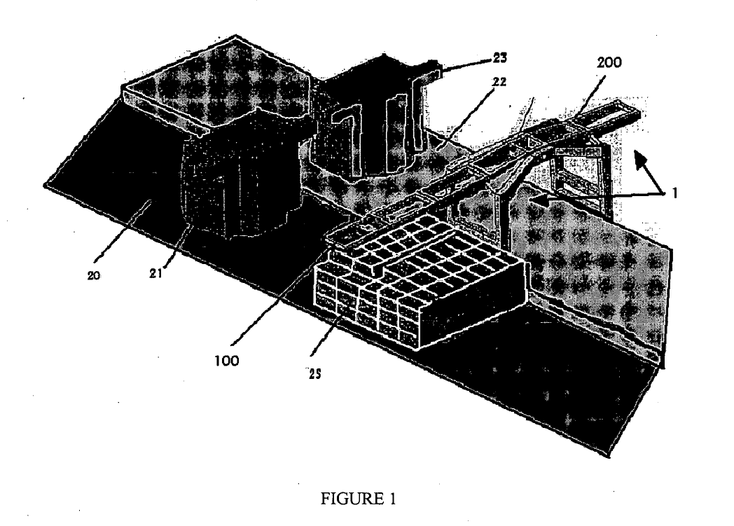

Referring now to FIG. 1, exemplary composite crane 1 comprises micro crane assembly 100, macro crane assembly 200 adapted to be in communication with and control motion of at least a portion of micro crane assembly 100, and controller 300 (not shown in the figures).

Composite crane 1 may be powered at least partially using enhanced motion control and energy storage such that force used to counteract the weight of the moving structure and load, i.e. composite crane 1 and cargo 25, is carried by an energy storage system (not shown in the figures) and oscillatory motions are driven by a separate device (not shown in the figures) such that the total energy input to accomplish the movements is minimized.

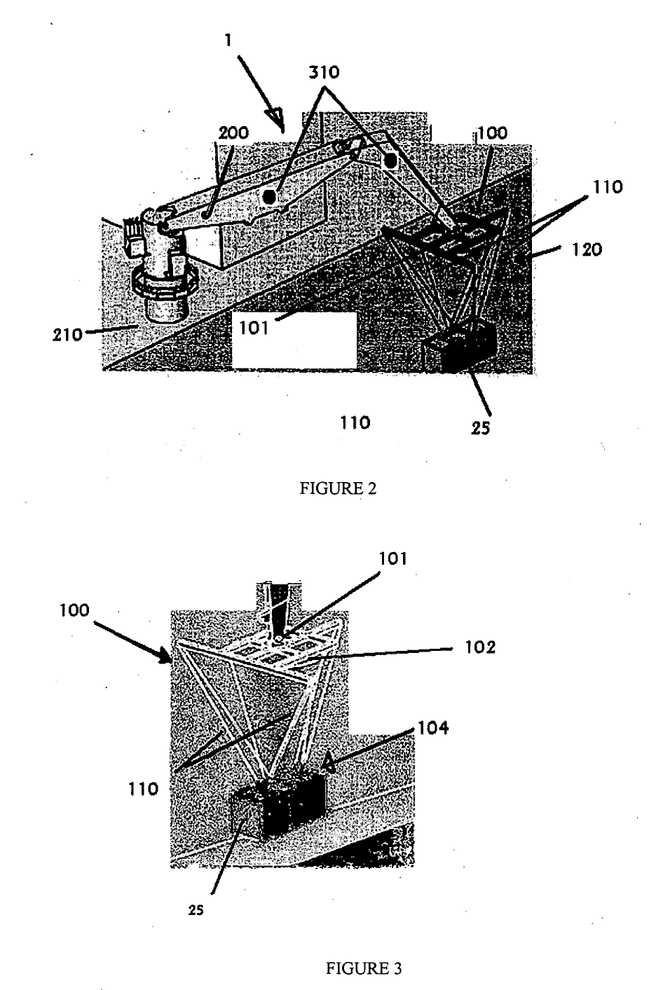

Referring now to FIG. 2 and FIG. 3, micro crane assembly 100 comprises lifting device 120 which may further comprise latch frame 104 (FIG. 3) and a plurality of cables 110 arranged and controlled such that latch frame 104 and its load, e.g. cargo 25, may be controlled in up to six degrees of freedom.

Macro crane assembly 200 is adapted to permit control of the motion of micro crane support point 101 and may further comprise support frame 102. Cables 110 may be connected or otherwise secured to support frame 102. Additionally, macro crane assembly 200 may be articulated as illustrated in FIG. 2.

In certain embodiments, macro crane assembly 200 is further adapted to be connected to base platform 210 or 22 (FIG. 1) and to be motion compensated with respect to base platform 210 and/or 22. For example, the connection may provide for rotation about an axis of base platform 210 or travel fore and aft on a ship such as 22. Further, motion compensation may occur in one or more of up to six degrees of freedom and may be used to aid in positioning and orienting micro crane assembly 100 in one or more planes defined by the one or more degrees of freedom.

Macro crane assembly 200 may be adapted to be configured to accommodate the structural configuration of the base platform 210 such as to enable the loads to be passed into strength members of base platform 210.

Controller 300 (not shown in the figures) is operatively in communication with micro crane assembly 100, macro crane assembly 200, or a combination thereof. Controller 300 may comprise one or more personal computers, programmable logic arrays, microcontrollers, systems based on a standard microprocessor, or the like, or a combination thereof. Moreover, controller 300 may be separate from or embedded within a component of composite crane 1, e.g. within macro crane assembly 200.

Additionally, one or more distributed sensors 310 may be present and operatively in communication with controller 300 or arrayed in a distributed control system operatively in communication with controller 300. Such distributed sensor(s) 310 may be used to sense, and thus help predict, motion of base platform 210 or ship 22 (FIG. 1) to which macro crane assembly 200 is connected, relative position and/or motion between base platform 210 or ship 22 to which macro crane assembly 200 is connected and a target platform such as platform 20 (FIG. 1), joint angle and speed of macro and micro crane components, relative motion and/or position between macro crane assembly 200 and micro crane assembly 100, relative motion and/or position between latch frame 104 (FIG. 3) and a target cargo on a target platform (e.g., cargo 25 on platform 20), relative motion and/or position between cargo 25 once lifted and the target platform for that cargo 25 (e.g., platform 20 or 22), or the like, or a combination thereof.

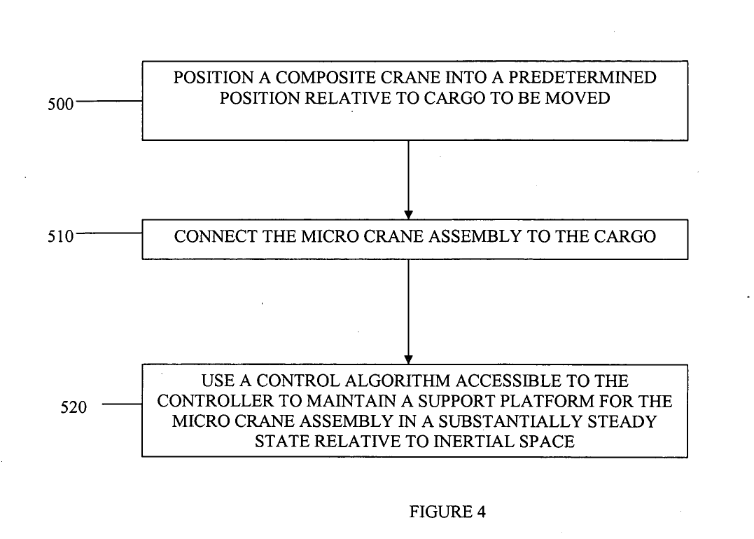

In the operation of exemplary embodiments, referring now to FIG. 4, cargo 25 (FIG. 1) may be handled by positioning composite crane 1 (FIG. 1) into a predetermined position relative to cargo 25. Composite crane 1 is as described above. Micro crane assembly 100 (FIG. 1) may be connected to cargo 25, e.g. using latch frame 104. Once connected, one or more control algorithms accessible to controller 300, e.g. in a permanent or transient memory store, are used to control macro crane assembly 200 and micro crane assembly 100 where the control algorithm is adapted to help maintain support frame 102 (FIG. 3) for micro crane assembly 100 in a substantially steady state relative to inertial space or moving to compensate for some of the movement of target platform 20 (FIG. 1). Steady state relative to inertial space, as used herein, is defined to mean the state of a mass in which there are no acceleration forces on it except gravity, i.e. it is still.

The control algorithm also helps maintain lifted cargo 25 (FIG. 1) in a symbiotic relationship with the target platform to which cargo 25 is to be delivered, compensating for the relative movements of cargo 25 and target platform 20. Accordingly, the control algorithm may be used by controller 300 to move latch frame 104 (FIG. 3) such that its motion relative to the target platform (and additionally cargo 25) is minimized, to move latch frame 104 and cargo 25 once lifted so that its motion relative to target platform 20 and nearby cargo 25 is minimized until lifted clear, or the like, or a combination thereof.

A kinematic control algorithm, which may be separate from or integrated into the control algorithm, may also be used to help maintain support point 101 of micro crane assembly 100 (FIG. 1) in a substantially steady state in inertial space despite motion of base platform 210 or ship 22 (FIG. 1).

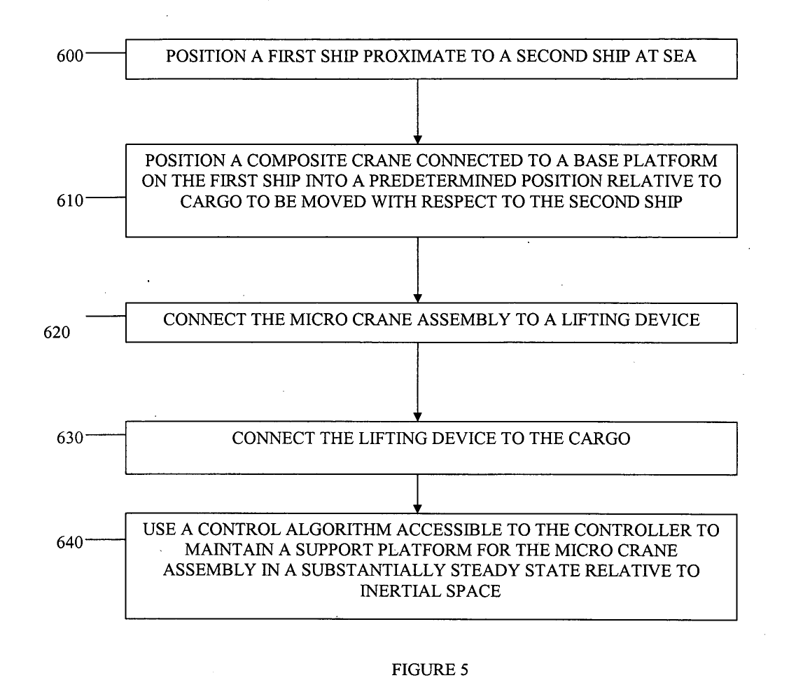

Referring now to FIG. 5, in a further exemplary method, objects, e.g. cargo 25 (FIG. 1), may be offloaded from two ships at sea. First ship 20 (FIG. 1) is positioned proximate to second ship 22 (FIG. 1), e.g. at sea. Composite crane 1 (FIG. 1), which is connected to base platform 210 (FIG. 2) on first ship 20, is positioned into a predetermined position relative to cargo 25 which is to be moved with respect to second ship 22, e.g. to or from second ship 22. First ship 20 and second ship 22 may be secured to or free of each other and may be at rest or moving, e.g. in a substantially parallel course. Additionally, first ship 20 and second ship 22 may be at rest but still moving with respect to each other due to wave motion.

Micro crane assembly 100 (FIG. 1) is connected to lifting device 120 (FIG. 2). Using a control algorithm accessible to controller 300, controller 300 maintains support platform 102 (FIG. 3) for micro crane assembly 100 in a substantially steady state relative to inertial space. As before, the control algorithm may further comprise an algorithm adapted help to move latch frame 104 (FIG. 3) so that its motion relative to the target platform (and cargo 25) is minimized, to move latch frame 104 and cargo 25 once lifted so that its motion relative to the target platform and nearby cargo 25 is minimized until lifted clear, or a combination thereof. The control algorithm may be used to control movement of latch frame 104 so that its motion relative to the target platform (and cargo) is minimized. Further, the macro crane compensation movement can be disabled (i.e. not moving) and composite crane 1 used to lower cargo 25 onto the deck of ship 22 under full six-degree-of-freedom control allowing the possibility of moving cargo on ship 22 while at sea with relatively little relative motion between cargo 25 and the deck. This can operate to increase control and safety of these operations.

Additionally, the control algorithm may be used to move macro crane assembly 200 to ensure that latch frame 104 remains substantially centered in the workspace of micro crane assembly 100.

The foregoing disclosure and description of the inventions are illustrative and explanatory. Various changes in the size, shape, and materials, as well as in the details of the illustrative construction and/or a illustrative method may be made without departing from the spirit of the invention.

We claim:

1. A composite crane, comprising:
a. a micro crane assembly, adapted to lift and lower cargo;
b. a macro crane assembly, adapted to be in communication with and control the motion of the micro crane assembly; and
c. a controller, further comprising a control algorithm and operatively in communication with at least one of (i) the micro crane assembly or (ii) the macro crane assembly, the controller adapted to maintain a predetermined portion of the composite crane in a substantially steady state relative to inertial space.

2. The composite crane of claim 1, wherein the macro crane assembly:
a. further comprises a micro crane supported point; and
b. is adapted to control motion of the micro crane assembly about the micro crane supported point.

3. The composite crane of claim 1, wherein the micro crane assembly further comprises:
a. a controllable latch frame adapted to be connected to a load; and
b. a plurality of cables arranged and adapted to be controlled such that movement of the controllable latch frame and its load are controllable in a predetermined number of degrees of freedom.

4. The composite crane of claim 3, wherein:
a. the controllable latch frame is an integral latch frame adapted to support cargo to be moved to or from a target platform; and
b. the micro crane assembly further comprises a support frame in communication with the controllable latch frame.

5. The composite crane of claim 3, wherein the predetermined number of degrees of freedom is six degrees of freedom.

6. The composite crane of claim 1, wherein the macro crane assembly is further adapted:
a. to be connected to a base platform; and
b. to be motion compensated with respect to the base platform.

7. The composite crane of claim 6, wherein the macro motion compensation:
a. occurs in at least one of six degrees of freedom; and
b. allows at least one of (i) positioning the micro crane assembly in at least one of six degrees of freedom or (ii) orienting the micro crane assembly in at least one of six degrees of freedom.

8. The composite crane of claim 1, wherein the macro crane assembly is adapted to accommodate a structural configuration of the base platform.

9. The composite crane of claim 1, further comprising at least one of (i) a distributed sensor operatively in communication with the controller or (ii) a distributed controller operatively in communication with the controller.

10. The composite crane of claim 9, wherein the distributed sensor is used to sense and predict at least one of (i) motion of a base platform to which the macro crane assembly is connected, (ii) relative motion and/or position between a base platform to which the macro crane assembly is connected and a target platform, (iii) relative motion and/or position between the macro crane assembly and the micro crane assembly, (iv) relative motion between a micro crane latch frame and a target cargo on a target platform, (v) a joint angle between a predetermined macro and micro crane component, (vi) a joint speed of a macro and micro crane component, or (vii) relative motion and/or position between the lifted cargo and the target platform.

11. A method of handling cargo, comprising:
a. positioning a composite crane into a predetermined position relative to cargo to be moved, the composite crane comprising:
i. a micro crane assembly, further comprising a support platform and a latch frame and adapted to control motion of the latch frame;
ii. a macro crane assembly adapted to be in communication with and control motion of the micro crane assembly; and
iii. a controller, operatively in communication with at least one of (a) the micro crane assembly or (b) the macro crane assembly;
b. connecting the micro crane assembly to the cargo; and
c. using a control algorithm accessible to the controller to maintain the support platform in a substantially steady state relative to inertial space.

12. The method of claim 11, wherein using a control algorithm further comprises at least one of (i) using a control algorithm accessible to the controller to move the latch frame so that its motion relative to the target platform (and cargo) is minimized or (ii) using a control algorithm accessible to the controller to move the latch frame and cargo once lifted so that its motion relative to the target platform and nearby cargo is minimized until lifted to a predetermined position.

13. The method of claim 11, wherein the controller is operatively in communication with a sensor useful to provide information to the controller.

14. The method of claim 11, further comprising powering the composite crane at least partially using enhanced motion control and energy storage.

15. A method of offloading an object from two ships at sea, comprising:
a. positioning a first ship proximate to a second ship at sea;
b. positioning a composite crane connected to a base platform on the first ship into a predetermined position relative to cargo to be moved with respect to the second ship, the composite crane comprising:
i. a micro crane assembly, comprising a controllable latch frame;
ii. a macro crane assembly adapted to be in communication with the micro crane assembly, the macro crane assembly connected to the base platform; and
iii. a controller, operatively in communication with at least one of (a) the micro crane assembly or (b) the macro crane assembly;
c. connecting the micro crane assembly to the cargo; and
d. using a control algorithm accessible to the controller to control the controllable latch frame in a predetermined number of degrees of freedom.

16. The method of claim 15, wherein using a control algorithm further comprises at least one of (i) using a control algorithm accessible to the controller to move the micro crane assembly so that its motion relative to the target platform (and cargo) is minimized or (ii) using a control algorithm accessible to the controller to move the micro crane assembly and cargo once lifted so that its motion relative to the target platform and nearby cargo is minimized until lifted to a predetermined position.

17. The method of claim 15, wherein the first ship and the second ship are at least one of (i) secured to each other, (ii) not secured to each other, (iii) at rest, or (iv) moving in a substantially parallel course.

18. The method of claim 15, further comprising using a kinematic control algorithm accessible to the controller to at least one of (i) maintain a suspension point of the micro crane assembly in a substantially steady state in inertial space despite motion of the base platform or (ii) moving to compensate for some of the movement of the target platform.

19. The method of claim 15, further comprising using a control algorithm accessible to the controller to move the latch frame so that motion of the latch frame relative to the target platform is maintained within a predetermined workspace.

20. The method of claim 15, further comprising using a control algorithm accessible to the controller to move the latch frame and cargo once lifted so that motion of the cargo relative to the target platform and nearby cargo is at least one of (i) minimized until lifted clear of the nearby cargo or (ii) such that the latching frame remains substantially centered in the workspace of the micro crane assembly.
